(19) United States
(12) Patent Application Publication
(10) Pub. No.: US 2025/0280444 A1
(43) Pub. Date: Sep. 4, 2025

(54) APPARATUS, SYSTEM, AND METHOD OF UNAVAILABILITY STATE FOR A MULTI-LINK DEVICE (MLD)

(71) Applicants: Dibakar Das, Hillsboro, OR (US); Dmitry Akhmetov, Hillsboro, OR (US); Daniel Bravo, Portland, OR (US); Laurent Cariou, Milizac (FR); Gil Meyuhas, Tel-Aviv (IL)

(72) Inventors: Dibakar Das, Hillsboro, OR (US); Dmitry Akhmetov, Hillsboro, OR (US); Daniel Bravo, Portland, OR (US); Laurent Cariou, Milizac (FR); Gil Meyuhas, Tel-Aviv (IL)

(21) Appl. No.: 19/202,959

(22) Filed: May 8, 2025

Related U.S. Application Data
(60) Provisional application No. 63/645,524, filed on May 10, 2024.

(51) Int. Cl. H04W 74/0816; H04W 8/22; H04W 48/02

(52) U.S. Cl. CPC H04W 74/0816; H04W 8/22; H04W 48/02

(57) ABSTRACT

For example, a non Access Point (AP) (non-AP) Multi-Link Device (MLD) may be configured to set unavailability signaling information to signal an unavailability state at which the non-AP MLD is to be unavailable for communication over a first link with an AP MLD during a Transmit Opportunity (TxOP). For example, the unavailability signaling information may be configured to signal whether or not the unavailability state is to be set for one or more second links between the non-AP MLD and the AP MLD during the TxOP. For example, the non-AP MLD may be configured to transmit a frame including the unavailability signaling information to the AP MLD over the first link during the TxOP.

### CROSS REFERENCE

This application claims the benefit of and priority from U.S. Provisional Patent Application No. 63/645,524 entitled “MECHANISM TO SIGNAL DETAILED SHORT-TERM COEXISTENCE IN WIFI-8”, filed May 10, 2024, the entire disclosure of which is incorporated herein by reference.

### BACKGROUND

According to some wireless communication protocols, a wireless communication station (STA) may be allowed to enter a power save mode, e.g., in order to reduce a power consumed by the STA.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of a multi-link communication scheme, which may be implemented in accordance with some demonstrative aspects.

FIG. 3 is a schematic illustration of a multi-link communication scheme, which may be implemented in accordance with some demonstrative aspects.

FIG. 4 is a schematic illustration of communications between a non Access Point (AP) (non-AP) Multi-Link Device (MLD) and an AP MLD, in accordance with some demonstrative aspects.

FIG. 5 is a schematic illustration of communications between a non-AP MLD and an AP MLD, in accordance with some demonstrative aspects.

FIG. 6 is a schematic illustration of communications between a non-AP MLD and an AP MLD, in accordance with some demonstrative aspects.

FIG. 7 is a schematic flow-chart illustration of a method of unavailability state of an MLD, in accordance with some demonstrative aspects.

FIG. 8 is a schematic flow-chart illustration of a method of unavailability state of an MLD, in accordance with some demonstrative aspects.

FIG. 9 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

The words “exemplary” and “demonstrative” are used herein to mean “serving as an example, instance, demonstration, or illustration”. A ny aspect, or design described herein as “exemplary” or “demonstrative” is not necessarily to be construed as preferred or advantageous over other aspects, or designs.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

The phrases “at least one” and “one or more” may be understood to include a numerical quantity greater than or equal to one, e.g., one, two, three, four, [ . . . ], etc. The phrase “at least one of” with regard to a group of elements may be used herein to mean at least one element from the group consisting of the elements. For example, the phrase “at least one of” with regard to a group of elements may be used herein to mean one of the listed elements, a plurality of one of the listed elements, a plurality of individual listed elements, or a plurality of a multiple of individual listed elements.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology-Telecommunications and Information Exchange between Systems Local and Metropolitan Area Networks-Specific Requirements; Part 11: Wireless LAN Medium Access Control (MAC) and Physical Layer (PHY) Specifications, December 2020); IEEE 802.11be (IEEE P 802.11be/D5.0 Draft Standard for Information technology-Telecommunications and information exchange between systems Local and metropolitan area networks-Specific requirements; Part 11: Wireless LAN Medium Access Control (MAC) and Physical Layer (PHY) Specifications; Amendment 8: Enhancements for extremely high throughput (EHT), November 2023); and/or IEEE802.11bn (IEEE 802.11bn/D0.2, IEEE Standard for Information Technology-Telecommunications and Information Exchange between Systems Local and Metropolitan Area Networks-Specific Requirements; Part 11: Wireless LAN Medium Access Control (MAC) and Physical Layer (PHY) Specifications-Amendment: Enhancements for Ultra High Reliability (UHR), March 2025)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™, Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

The terms “processor” or “controller” may include, for example, any kind of technological entity that allows handling of any suitable type of data and/or information. The data and/or information may be handled according to one or more specific functions executed by the processor or controller. Further, a processor or a controller may be understood as any kind of circuitry, e.g., including any kind of analog and/or digital circuitry. A processor or a controller may be or may include analog circuitry, digital circuitry, mixed-signal circuitry, logic circuitry, processor, microprocessor, Central Processing Unit (CPU), Graphics Processing Unit (GPU), Digital Signal Processor (DSP), Field Programmable Gate Array (FPGA), integrated circuit, Application Specific Integrated Circuit (A SIC), one or more processor cores, a single-core processor, a dual-core processor, a multiple-core processor, a host processor, a chip, a microchip, one or more circuits, circuitry, a logic unit, an Integrated Circuit (IC), any other suitable multi-purpose or specific processor or controller, and the like, or any combination thereof. Any other kind of implementation of the respective functions, which will be described below in further detail, may also be understood as a processor, controller, or logic circuit. It is understood that any two (or more) processors, controllers, or logic circuits detailed herein may be realized as a single entity with equivalent functionality or the like, and conversely that any single processor, controller, or logic circuit detailed herein may be realized as two (or more) separate entities with equivalent functionality or the like.

The term “memory” may include, for example, any type of technological entity, for example, a storage medium, for example, a computer-readable medium (e.g., a non-transitory computer-readable medium), and/or any other suitable medium, in which data or information can be stored for retrieval. For example, references to “memory” may refer to volatile or non-volatile memory, including random access memory (RAM), read-only memory (ROM), dynamic RAM (DRAM), synchronous DRAM (SD-RAM), a flash memory, a volatile memory, a non-volatile memory, a cache memory, a buffer, a short term memory, a long term memory, among others, or any combination thereof. Registers, shift registers, processor registers, data buffers, among others, are also embraced herein by the term memory.

Some demonstrative aspects may be used in conjunction with a WLAN, e.g., a Wi-Fi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a sub-7 GHz frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 GHz and 300 GHz, for example, a frequency band above 40 GHz, for example, a frequency band above 45 GHz, e.g., a 60 GHz frequency band, a frequency band between 42.5 GHz and 71 GHz, and/or any other mmWave frequency band.

Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

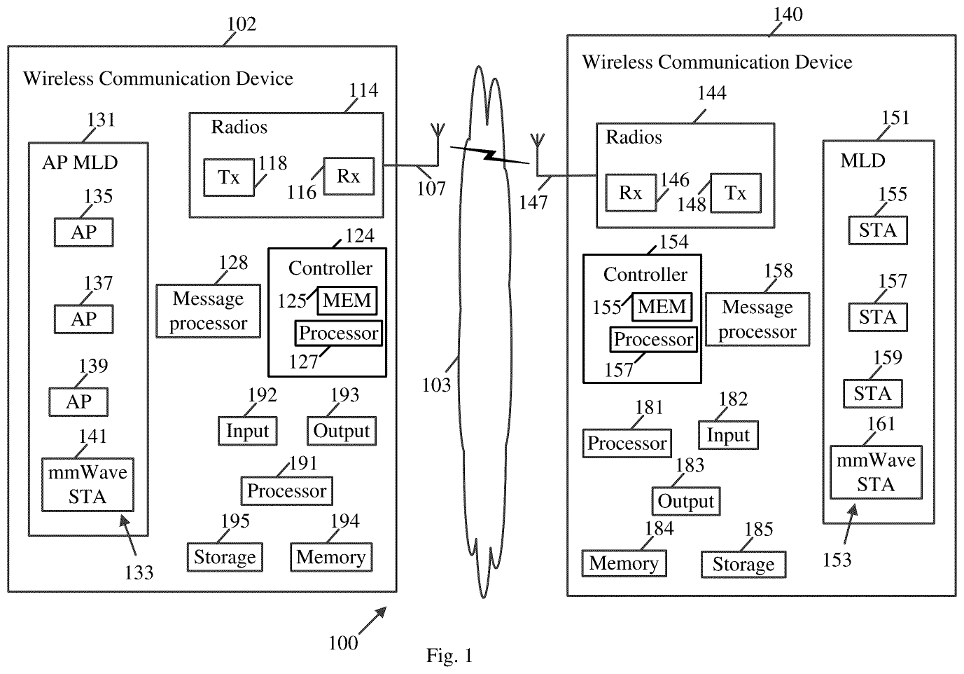

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, and/or one or more other devices.

In some demonstrative aspects, devices 102 and/or 140 may include a mobile device or a non-mobile, e.g., a static, device.

For example, devices 102, and/or 140 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UM D), an Ultra Mobile PC (UM PC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player, or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102 and/or 140 may be capable of communicating content, data, information and/or signals via a wireless medium (W M) 103. In some demonstrative aspects, wireless medium 103 may include, for example, a radio channel, an RF channel, a Wi-Fi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 GHz wireless communication frequency band, for example, one or more channels in a sub-7 GHz wireless communication frequency band, for example, one or more channels in a 2.4 GHz wireless communication frequency band, one or more channels in a 5 GHz wireless communication frequency band, and/or one or more channels in a 6 GHz wireless communication frequency band. For example, WM 103 may additionally or alternatively include one or more channels in an mmWave wireless communication frequency band, for example, one or more channels in a frequency band above 40 GHz, for example, one or more channels in a frequency band above 45 GHz, e.g., one or more channels in a 60 GHz frequency band, one or more channels in a frequency band between 42.5 GHz and 71 GHz, and/or one or more channels in any other mmWave frequency band.

In other aspects, WM 103 may include any other type of channel over any other frequency band.

In some demonstrative aspects, device 102 and/or device 140 may include one or more radios including circuitry and/or logic to perform wireless communication between devices 102, 140, and/or one or more other wireless communication devices. For example, device 102 may include one or more radios 114, and/or device 140 may include one or more radios 144.

In some demonstrative aspects, radios 114 and/or 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a sub-10 GHz band, for example, a sub-7 GHz band, for example, a 2.4 GHz band, a 5 GHz band, a 6 GHz band, and/or any other sub-10 GHz and/or sub-7 GHz band; and/or an mmWave band, e.g., a 45 GHz band, a 60 GHz band, a band between 42.5 GHz and 71 GHz, and/or any other mmWave band; and/or any other band, e.g., a 5G band, an S1G band, and/or any other band.

In some demonstrative aspects, radios 114 and/or 144 may include, or may be associated with one or more antennas.

In some demonstrative aspects, device 102 may include one or more antennas 107, and/or device 140 may include one or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors 127 including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory 125, e.g., coupled to the one or more processors 127, which may be configured, for example, to store, e.g., at least temporarily, at least some of the information processed by the one or more processors and/or circuitry 127, and/or which may be configured to store logic to be utilized by the processors and/or circuitry 127.

In one example, controller 154 may include circuitry and/or logic, for example, one or more processors 157 including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory 155, e.g., coupled to the one or more processors 157, which may be configured, for example, to store, e.g., at least temporarily, at least some of the information processed by the one or more processors and/or circuitry 157, and/or which may be configured to store logic to be utilized by the processors and/or circuitry 157.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or the one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102 and/or device 140 may include, operate as, perform the role of, and/or perform one or more functionalities of, one or more STAs. For example, device 102 may include at least one STA, and/or device 140 may include at least one STA.

In some demonstrative aspects, device 102 and/or device 140 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAS.

In some demonstrative aspects, for example, device 102 and/or device 140 may be configured to perform one or more operations, and/or functionalities of a Wi-Fi 8 STA.

In other aspects, for example, devices 102 and/or 140 may be configured to perform one or more operations, and/or functionalities of an Ultra High Reliability (UHR) STA.

In other aspects, for example, devices 102 and/or 140 may be configured to perform one or more operations, and/or functionalities of an Integrated mmWave (IM MW) STA.

In other aspects, for example, devices 102 and/or 140 may be configured to perform one or more operations, and/or functionalities of any other additional or alternative type of STA.

In other aspects, devices 102, and/or 140 may include, operate as, perform the role of, and/or perform one or more functionalities of, any other wireless device and/or station, e.g., a WLAN STA, a Wi-Fi STA, and the like.

In some demonstrative aspects, device 102 and/or device 140 may be configured to operate as, perform the role of, and/or perform one or more functionalities of, an access point (AP), e.g., an EHT AP STA, aUHR AP STA, and/or an IM MW AP STA.

In some demonstrative aspects, device 102 and/or device 140 may be configured to operate as, perform the role of, and/or perform one or more functionalities of, a non-AP STA, e.g., an EHT non-AP STA, a UHR non-AP STA, and/or an IM M W non-AP STA.

In other aspects, device 102 and/or device 140 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects devices 102 and/or 140 may be configured to communicate in an EHT network, a UHR network, an IM MW network, and/or any other network.

In some demonstrative aspects, devices 102, 140 and/or 150 may be configured to operate in accordance with one or more Specifications, for example, including one or more IEEE 802.11 Specifications, e.g., an IEEE 802.11-2020 Specification, an IEEE 802.11be Specification, an IEEE 802.11-2020 Specification, an IEEE 802.11bn Specification, and/or any other specification and/or protocol.

In some demonstrative aspects, device 102 and/or device 140 may include, operate as, perform a role of, and/or perform the functionality of, one or more multi-link logical entities, e.g., as described below.

In other aspect, device 102 and/or device 140 may include, operate as, perform a role of, and/or perform the functionality of, any other entities, e.g., which are not multi-link logical entities.

For example, a multi-link logical entity may include a logical entity that contains one or more STAs. The logical entity may have one MAC data service interface and primitives to the logical link control (LLC) and a single address associated with the interface, which can be used to communicate on a distribution system medium (DSM). For example, the DSM may include a medium or set of media used by a distribution system (DS) for communications between APs, mesh gates, and the portal of an extended service set (ESS). For example, the DS may include a system used to interconnect a set of basic service sets (BSSs) and integrated local area networks (LANs) to create an extended service set (ESS). In one example, a multi-link logical entity may allow STAs within the multi-link logical entity to have the same MAC address. The multi-link entity may perform any other additional or alternative functionality.

In some demonstrative aspects, device 102 and/or device 140 may include, operate as, perform a role of, and/or perform the functionality of, a Multi-Link Device (MLD). For example, device 102 may include, operate as, perform a role of, and/or perform the functionality of, at least one MLD, and/or device 140 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102 and/or device 140 may be configured to operate as, perform the role of, and/or perform one or more functionalities of, an AP MLD.

In some demonstrative aspects, device 102 and/or device 140 may be configured to operate as, perform the role of, and/or perform one or more functionalities of, a non-AP MLD.

In other aspects, device 102 and/or device 140 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In one example, a multi-link infrastructure framework may be configured as an extension from a one link operation between two STAs, e.g., an AP and a non-AP STA.

In some demonstrative aspects, controller 124 may be configured to control, trigger, cause, and/or instruct device 102 to operate as, perform a role of, and/or perform one or more operations and/or functionalities of, an AP MLD 131 including a plurality of STAs 133, e.g., including an AP STA 135, an AP STA 137, an AP STA 139, and/or an mmWave STA 141, which may be affiliated with the AP MLD 131. In some aspects, as shown in FIG. 1, AP MLD 131 may include four STAs. In other aspects, AP MLD 131 may include any other number of STAs.

In one example, AP STA 135, AP STA 137, AP STA 139, and/or mmWave STA 141 may operate as, perform a role of, and/or perform one or more operations and/or functionalities of, an EHT AP STA. In other aspects, AP STA 135, AP STA 137, AP STA 139, and/or mmWave STA 141 may perform any other additional or alternative functionality.

In some demonstrative aspects, mmWave STA 141 may operate as, perform a role of, and/or perform one or more operations and/or functionalities of, an mmWave AP STA. In other aspects, mmWave STA 141 may operate as, perform a role of, and/or perform one or more operations and/or functionalities of an mmWave network controller to control communication over an mmWave wireless communication network.

In some demonstrative aspects, for example, the one or more radios 114 may include, for example, a radio for communication by AP STA 135 over a first wireless communication frequency channel and/or frequency band, e.g., a 2.4 GHz band, as described below.

In some demonstrative aspects, for example, the one or more radios 114 may include, for example, a radio for communication by AP STA 137 over a second wireless communication frequency channel and/or frequency band, e.g., a 5 GHz band, as described below.

In some demonstrative aspects, for example, the one or more radios 114 may include, for example, a radio for communication by AP STA 139 over a third wireless communication frequency channel and/or frequency band, e.g., a 6 GHz band, as described below.

In some demonstrative aspects, for example, the one or more radios 114 may include, for example, a radio for communication by mmWave STA 141 over a fourth wireless communication frequency channel and/or frequency band, e.g., an mmWave band, for example, a wireless communication band above 40 GHz, for example, a frequency band above 45 GHz, e.g., a 60 GHz frequency band, a frequency band between 42.5 GHz and 71 GHz, and/or any other mmWave frequency band, e.g., as described below.

In some demonstrative aspects, the radios 114 utilized by STAs 133 may be implemented as separate radios. In other aspects, the radios 114 utilized by STAs 133 may be implemented by one or more shared and/or common radios and/or radio components.

In other aspects, controller 124 may be configured to control, trigger, cause, and/or instruct device 102 to operate as, perform a role of, and/or perform one or more operations and/or functionalities of, any other additional or alternative entity and/or STA, e.g., a single STA, multiple STAs, and/or a non-MLD entity.

In some demonstrative aspects, controller 154 may be configured to control, trigger, cause, and/or instruct device 140 to operate as, perform a role of, and/or perform one or more operations and/or functionalities of, an MLD 151 including a plurality of STAs 153, e.g., including a STA 155, a STA 157, a STA 159, and/or a STA 161, which may be affiliated with the MLD 151. In some aspects, as shown in FIG. 1, MLD 151 may include four STAs. In other aspects, MLD 151 may include any other number of STAS.

In one example, STA 155, STA 157, STA 159, and/or STA 161 may operate as, perform a role of, and/or perform one or more operations and/or functionalities of, an EHT STA. In other aspects, STA 155, STA 157, STA 159, and/or STA 161 may perform any other additional or alternative functionality.

In some demonstrative aspects, STA 161 may be configured to operate as, perform a role of, and/or perform one or more operations and/or functionalities of, an mmWave STA, e.g., as described below. For example, the mmWave STA 161 may be configured to operate as, perform a role of, and/or perform one or more operations and/or functionalities of, a non-AP mmWave STA, e.g., as described below.

In some demonstrative aspects, for example, the one or more radios 144 may include, for example, a radio for communication by STA 155 over a first wireless communication frequency channel and/or frequency band, e.g., a 2.4 GHz band, as described below.

In some demonstrative aspects, for example, the one or more radios 144 may include, for example, a radio for communication by STA 157 over a second wireless communication frequency channel and/or frequency band, e.g., a 5 GHz band, as described below.

In some demonstrative aspects, for example, the one or more radios 144 may include, for example, a radio for communication by STA 159 over a third wireless communication frequency channel and/or frequency band, e.g., a 6 GHz band, as described below.

In some demonstrative aspects, for example, the one or more radios 144 may include, for example, a radio for communication by mmWave STA 161 over a fourth wireless communication frequency channel and/or frequency band, e.g., an mmWave band, as described below.

In some demonstrative aspects, the radios 144 utilized by STAs 153 may be implemented as separate radios. In other aspects, the radios 144 utilized by STAs 153 may be implemented by one or more shared and/or common radios and/or radio components.

In some demonstrative aspects, controller 154 may be configured to control, trigger, cause, and/or instruct MLD 151 to operate as, perform a role of, and/or perform one or more operations and/or functionalities of, a non-AP MLD. For example, STA 155, STA 157, STA 159, and/or mmWave STA 161 may operate as, perform a role of, and/or perform one or more operations and/or functionalities of, a non-AP STA, e.g., a non-AP EHT STA.

In some demonstrative aspects, controller 154 may be configured to control, trigger, cause, and/or instruct MLD 151 to operate as, perform a role of, and/or perform one or more operations and/or functionalities of, an AP MLD. For example, STA 155, STA 157, STA 159, and/or mmWave STA 161 may operate as, perform a role of, and/or perform one or more operations and/or functionalities of, an AP EHT STA.

In other aspects, controller 154 may be configured to control, trigger, cause, and/or instruct device 140 to operate as, perform a role of, and/or perform one or more operations and/or functionalities of, any other additional or alternative entity and/or STA, e.g., a single STA, multiple STAs, and/or a non-MLD entity.

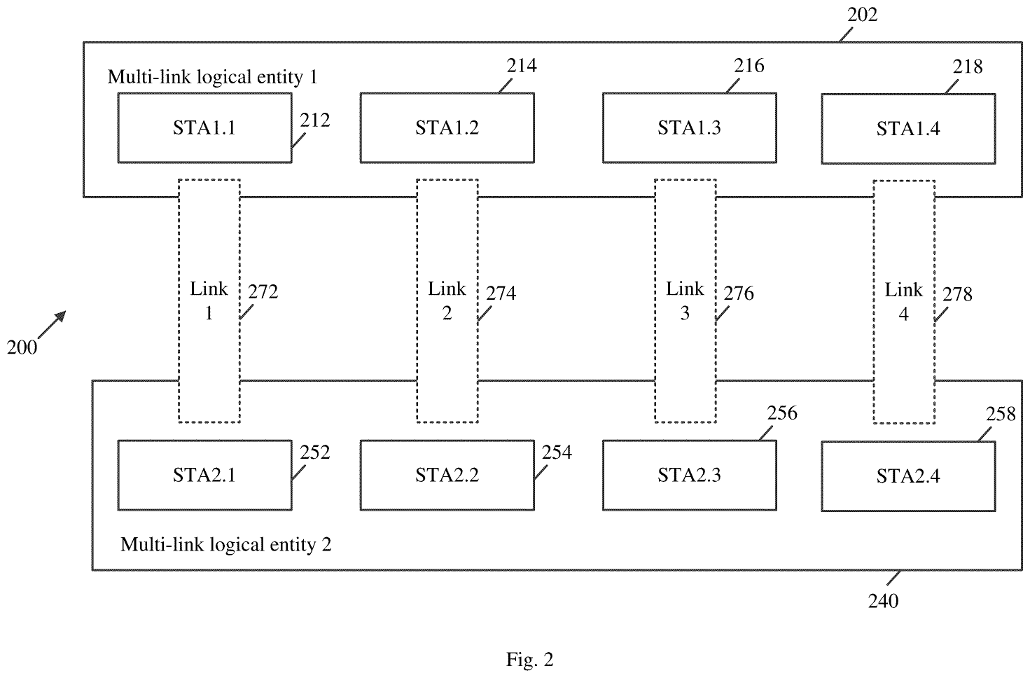

Reference is made to FIG. 2, which schematically illustrates a multi-link communication scheme 200, which may be implemented in accordance with some demonstrative aspects.

As shown in FIG. 2, a first multi-link logical entity 202 (“multi-link logical entity 1”), e.g., a first MLD, may include a plurality of STAs, e.g., including a STA 212, a STA 214, a STA 216, and a STA 218. In one example, AP MLD 131 (FIG. 1) may perform one or more operations of, one or more functionalities of, the role of, and/or the functionality of, multi-link logical entity 202.

As shown in FIG. 2, a second multi-link logical entity 240 (“multi-link logical entity 2”), e.g., a second MLD, may include a plurality of STAs, e.g., including a STA 252, a STA 254, a STA 256, and a STA 258. In one example, MLD 151 (FIG. 1) may perform one or more operations of, one or more functionalities of, the role of, and/or the functionality of, multi-link logical entity 240.

As shown in FIG. 2, multi-link logical entity 202 and multi-link logical entity 240 may be configured to form, setup and/or communicate over a plurality of links, for example, including a link 272 between STA 212 and STA 252, a link 274 between STA 214 and STA 254, a link 276 between STA 216 and STA 256, and/or a link 278 between STA 218 and STA 258.

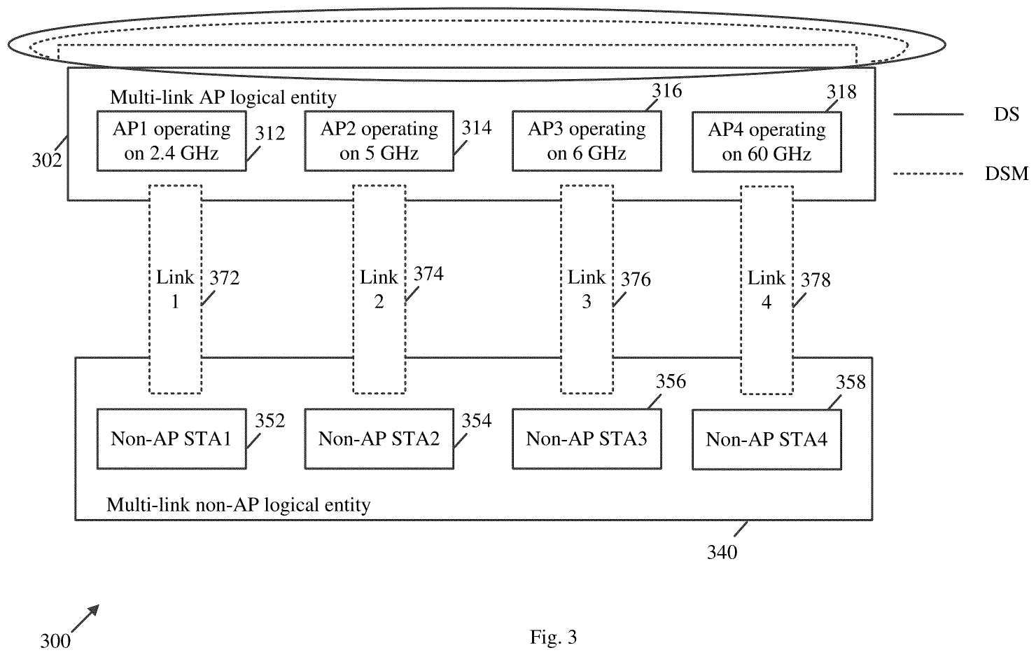

Reference is made to FIG. 3, which schematically illustrates a multi-link communication scheme 300, which may be implemented in accordance with some demonstrative aspects.

As shown in FIG. 3, a multi-link AP logical entity 302, e.g., an AP MLD, may include a plurality of AP STAS, e.g., including an AP STA 312, an AP STA 314, an AP STA 316, and an mmWave STA 318. In one example, AP MLD 131 (FIG. 1) may perform one or more operations of, one or more functionalities of, the role of, and/or the functionality of, multi-link AP logical entity 302.

As shown in FIG. 3, a multi-link non-AP logical entity 340, e.g., a non-AP MLD, may include a plurality of non-AP STAs, e.g., including a non-AP STA 352, a non-AP STA 354, a non-AP STA 356, and an mmWave STA 358. In one example, MLD 151 (FIG. 1) may perform one or more operations of, one or more functionalities of, the role of, and/or the functionality of, multi-link non-AP logical entity 340.

As shown in FIG. 3, multi-link AP logical entity 302 and multi-link non-AP logical entity 340 may be configured to form, setup and/or communicate over a plurality of links, for example, including a link 372 between AP STA 312 and non-AP STA 352, a link 374 between AP STA 314 and non-AP STA 354, a link 376 between AP STA 316 and non-AP STA 356, and/or a link 378 between mmWave STA 318 and mmWave STA 358.

For example, as shown in FIG. 3, multi-link AP logical entity 302 may include a multi-band AP MLD, which may be configured to communicate over a plurality of wireless communication frequency bands. For example, as shown in FIG. 3, AP STA 312 may be configured to communicate over a 2.4 GHz frequency band, AP STA 314 may be configured to communicate over a 5 GHz frequency band, AP STA 316 may be configured to communicate over a 6 GHz frequency band, and/or mmWave STA 318 may be configured to communicate over an mmWave frequency band. In other aspects, AP STA 312, AP STA 314, AP STA 316, and/or mmWave STA 318 may be configured to communicate over any other additional or alternative wireless communication frequency bands.

Referring back to FIG. 1, in some demonstrative aspects, device 102 and/or device 140 may be configured to perform one or more operations of an MLD unavailability mechanism, which may be configured to signal an unavailability state for an MLD, e.g., as describe below.

In some demonstrative aspects, device 102 and/or device 140 may be configured to perform one or more operations of an MLD unavailability mechanism, which may be configured to provide a technical solution to support signaling short-term coexistence, for example, detailed short-term coexistence, for an MLD, e.g., as described below.

For example, a first type of coexistence indication (signaling) (also referred to as “long-term coexistence indication (signaling)”) may be configured to provide a technical solution with respect to long-term and/or predictable coexistence issues.

In one example, a non-AP STA may a-priori know its unavailability, e.g., its periodic unavailability, for example, which may be due to peer-to-peer (P2P) operations, and/or due to any other reason.

For example, the non-AP STA may inform its associated AP of this predicted unavailability, for example, such that the AP may know when not to communicate with this non-AP STA.

For example, a second type of coexistence indication (signaling) (also referred to as “short-term coexistence indication (signaling)”) may be configured to provide a technical solution with respect to short-term and/or predictable coexistence issues.

For example, a non-AP STA may be aware of such unavailability events, e.g., just before they occur.

In one example, this type of unavailability events may occur, for example, during a Transmit Opportunity (TxOP), and/or at any other time.

For example, the non-AP STA may not be available to communicate over a particular link or frequency band.

In one example, the non-AP STA may not be available to communicate with an AP over a 2.4 GHz band, for example, due to BT operations on the 2.4 GHz band. However, the non-AP STA may be available to communicate with the AP on one or more other links and/or frequency bands, e.g., links in the 5 GHz band and/or the 6 GHz band.

In some demonstrative aspects, device 102 and/or device 140 may be configured to perform one or more operations of an MLD unavailability mechanism, which may be configured to provide a technical solution to support a non-AP STA to dynamically signal its availability/unavailability information to an AP, e.g., as described below.

In some demonstrative aspects, device 102 and/or device 140 may be configured to perform one or more operations of an MLD unavailability mechanism, which may be configured to provide a technical solution to support the non-AP STA to dynamically signal its availability/unavailability information to the AP, for example, with respect to short-term, unpredicted, and/or non-periodic evets, e.g., as described below.

In some demonstrative aspects, device 102 and/or device 140 may be configured to perform one or more operations of an MLD unavailability mechanism, which may be configured to provide a technical solution to support the non-AP STA to dynamically signal its availability/unavailability information to the AP, for example, during a TxOP, e.g., as described below.

In some demonstrative aspects, the MLD unavailability mechanism may be configured to provide a technical solution to support the non-AP STA to signal its availability/unavailability information to the AP during a TxOP, for example, on a per-link basis, e.g., as described below.

In some demonstrative aspects, device 102 and/or device 140 may be configured to perform one or more operations of an MLD unavailability mechanism, which may be configured to provide a technical solution to support the non-AP STA to dynamically signal its availability/unavailability information to the AP, for example, in an Initial Control Frame (ICF) and/or any other suitable type of frame, for example, in case the non-AP STA is in a role of a TxOP holder, which is to be unavailable after some time since starting the TxOP, e.g., as described below.

In some demonstrative aspects, device 102 and/or device 140 may be configured to perform one or more operations of an MLD unavailability mechanism, which may be configured to provide a technical solution to support the non-AP STA to dynamically signal its availability/unavailability information to the AP, for example, in a response to an ICF, a Block Acknowledge (BA) frame and/or any other suitable type of frame, for example, in case the non-AP STA is in a role of a TxOP responder, e.g., as described below.

In some demonstrative aspects, device 102 and/or device 140 may be configured to perform one or more operations of an MLD unavailability mechanism, which may be configured to provide a technical solution to support a non-AP MLD to dynamically signal its availability/unavailability information to an AP MLD, for example, while differentiating between link-specific coexistence cases versus MLD-specific coexistence cases, e.g., as described below.

For example, a link-specific coexistence case may occur when a non-AP MLD may temporarily lose its ability to communicate with its associated AP MLD on a specific link. For example, a BT operation on the 2.4 GHz frequency band may affect communications by a STA of the non-AP MLD operating over a link on the 2.4 GHz frequency band. For example, in such link-specific coexistence case the non-AP MLD may still be able to communicate with the AP MLD over one or more other links, e.g., over links in the 5 GHz frequency band and/or the 6 GHz frequency band.

For example, an MLD-specific coexistence case may occur when a non-AP MLD may lose its ability to communicate with its associated AP MLD altogether, e.g., over all links. For example, an MLD-specific coexistence case may occur when a single radio non-AP MLD has unpredictable P2P operation and/or starts a ranging operation with an unassociated AP, which would require the non-AP MLD to use its single radio.

For example, the MLD unavailability mechanism may be configured to provide a technical solution to support the AP MLD in a decision how to handle the unavailability state of the non-AP MLD, for example, based on the differentiation between link-specific coexistence cases versus MLD-specific coexistence cases, e.g., as described below.

For example, the AP MLD may perform one or more first operations with respect to communication with the non-AP MLD, for example, based on a signaling from the non-AP MLD that the non-AP MLD is to be unavailable due to a link-specific coexistence case.

For example, the AP MLD may perform one or more second operations, e.g., different from the first operations, with respect to communication with the non-AP MLD, for example, based on a signaling from the non-AP MLD that the non-AP MLD is to be unavailable due to an MLD-specific coexistence case.

In some demonstrative aspects, device 102 and/or device 140 may be configured to perform one or more operations of an MLD unavailability mechanism, which may be configured to provide a technical solution to support a non-AP MLD to dynamically signal its availability/unavailability information to an AP MLD, for example, with improved, e.g., increased, coexistence signaling granularity, e.g., as described below.

In some demonstrative aspects, the improved, e.g., increased, coexistence signaling granularity may be utilized, for example, to provide a technical solution to support improved medium efficiency, improved latency, and/or improved power efficiency, e.g., as described below.

In some demonstrative aspects, device 102 and/or device 140 may be configured to perform one or more operations of an MLD unavailability mechanism, which may be configured to provide a technical solution to support a non-AP MLD to dynamically signal its availability/unavailability information to an AP MLD, for example, while signaling (indicating) whether an unavailability state signaled (indicated) by a non-AP STA of the non-AP LD is to is to be applied at an MLD level or a STA level, e.g., as described below.

In some demonstrative aspects, device 102 and/or device 140 may be configured to perform one or more operations of an MLD unavailability signaling mechanism, which may be configured to provide a technical solution to support the non-AP MLD to signal to the AP MLD whether the non-AP MLD is to be at an unavailable state over a particular link between the non-AP MLD and the AP MLD, e.g., as described below.

In some demonstrative aspects, device 102 and/or device 140 may be configured to perform one or more operations of an MLD unavailability signaling mechanism, which may be configured to provide a technical solution to support the non-AP MLD to signal to the AP MLD whether the non-AP MLD is to be at an unavailable state over only some of the links between the non-AP MLD and the AP MLD, e.g., as described below.

In some demonstrative aspects, device 102 and/or device 140 may be configured to perform one or more operations of an MLD unavailability signaling mechanism, which may be configured to provide a technical solution to support the non-AP MLD to signal to the AP MLD whether the non-AP MLD is to be at an unavailable state over all of the links between the non-AP MLD and the AP MLD, e.g., as described below.

In some demonstrative aspects, device 102 and/or device 140 may be configured to perform one or more operations of an MLD unavailability signaling mechanism, which may be configured to provide a technical solution to support the non-AP MLD to signal to the AP MLD a dependency between availability/unavailability of two or more links between the non-AP MLD and the AP MLD, e.g., as described below.

For example, the MLD unavailability signaling mechanism, which may be configured to provide a technical solution to support the non-AP MLD to signal to the AP MLD that when the non-AP MLD is to be unavailable over a first link, then the non-AP MLD is to be unavailable over a second link, e.g., as described below.

For example, the MLD unavailability signaling mechanism, which may be configured to provide a technical solution to support the non-AP MLD to signal to the AP MLD that when the non-AP MLD is to be unavailable over a first link, then the non-AP MLD is to be available over a second link, e.g., as described below.

For example, the MLD unavailability signaling mechanism, which may be configured to provide a technical solution to support the non-AP MLD to signal to the AP MLD that when the non-AP MLD is to be unavailable over a particular link over a particular frequency band, then the non-AP MLD is to be unavailable over any other links over the particular frequency band, e.g., as described below.

For example, the MLD unavailability signaling mechanism, which may be configured to provide a technical solution to support the non-AP MLD to signal to the AP MLD that when the non-AP MLD is to be unavailable over a particular link over a particular frequency band, then the non-AP MLD is to be available over one or more, e.g., some or all, other links over the particular frequency band, e.g., as described below.

For example, the MLD unavailability signaling mechanism, which may be configured to provide a technical solution to support the non-AP MLD to signal to the AP MLD that when the non-AP MLD is to be unavailable over a particular link over a particular frequency band, then the non-AP MLD is to be available over one or more, e.g., some or all, other links over another frequency band, e.g., as described below.

In other aspects, the MLD unavailability signaling mechanism may be utilized to signal any other dependency and/relationship between the availability/unavailability states over different links.

In some demonstrative aspects, device 102 and/or device 140 may be configured to perform one or more operations of an MLD unavailability signaling mechanism, which may be configured to provide a technical solution to support an Enhanced Multi Link Single Radio (EMLSR) operation mode (EMLSR mode), e.g., as described below.

In some demonstrative aspects, the EMLSR operation mode may be defined, e.g., in compliance with an IEEE 802.11be Specification, to include a mode of operation that allows a non-AP MLD with multiple receive chains to listen on a set of enabled links, for example, when the corresponding STAs affiliated with the non-AP MLD are in the awake state, for an initial control frame sent by an AP affiliated with an AP MLD. For example, the initial control frame may be sent by the AP in a non-high-throughput (non-HT) (duplicate) PPDU, for example, with one spatial stream. For example, the initial control frame may be followed by one or more frame exchanges on the link on which the initial Control frame was received. In other aspects, the EMLSR operation mode may be defined to include any other additional or alternative suitable functionality.

Some demonstrative aspects are described herein with respect to a wireless communication device, e.g., wireless communication device 102 and/or wireless communication device 140, operating according to an EMLSR operation mode. Other aspects may be implemented with respect to a wireless communication device, e.g., wireless communication device 102 and/or wireless communication device 140, operating according to any other additional or alternative multi-link operation mode.

In some demonstrative aspects, device 102 and/or device 140 may be configured to perform one or more operations of an MLD unavailability signaling mechanism, which may be configured to provide a technical solution to support a short-term unavailability indication at a STA level by a STA in an EMLSR mode, e.g., as described below.

In some demonstrative aspects, the MLD unavailability signaling mechanism may be configured to provide a technical solution to support the STA in the EMLSR mode in signaling to its associated AP whether the signaled unavailability is due to EMLSR constraints or not, e.g., as described below.

In some demonstrative aspects, a non-AP STA may operate in the EMLSR mode. For example, in some use cases, the non-AP STA in the EMLSR mode may operate on two asymmetric links, e.g., an 80 MHz link and a 40 MHz link.

In some demonstrative aspects, an AP may inefficiently try to initiate a DL data transmission to the non-AP STA on the narrow-band link, e.g., on the 40 MHz link, for example, for a time duration, which may be longer than any Network Allocation Vector (NAV) set on the higher BW link, e.g., the 80 MHz link. For example, in one use case, the STA may have UL traffic that could suffer from the inefficient usage of the medium by the AP.

In some demonstrative aspects, the non-AP STA may be configured to use the coexistence signaling, for example, in order to truncate the duration of the DL transmission from the AP, for example, in order to allow the non-AP STA to transmit the UL transmission to the AP.

In one example, the non-AP STA may utilize a short-term signaling, e.g., by signaling an unavailability duration of 0 in an Initial Control Response (ICR) frame, that the AP is to truncate the duration of the DL transmission. However, this signaling of the unavailability duration of 0 in the ICR may still leave some degree of ambiguity on the AP side, as the AP may not be aware of the reason for truncating the duration of the DL transmission. For example, the AP may still attempt to send another PPDU to the non-AP STA, e.g., after a Short Inter-Frame-Space (SIFS), in the same TX OP.

In some demonstrative aspects, device 102 and/or device 140 may be configured to perform one or more operations of an MLD unavailability signaling mechanism, which may be configured to provide a technical solution to support the non-AP MLD to signal to the AP MLD a reason for truncating the duration of the DL transmission, e.g., as described below.

In some demonstrative aspects, the MLD unavailability signaling mechanism may be configured to provide a technical solution to support the non-AP STA to signal to the AP that the non-AP STA is truncating the TxOP initiated by the AP, for example, because of an inefficient choice of a link for EMLSR operations, e.g., as described below.

In some demonstrative aspects, controller 154 may be configured to control, trigger, cause, and/or instruct a non-AP MLD 151 implemented by device 140 to set unavailability signaling information to signal an unavailability state at which the non-AP MLD is to be unavailable for communication over a first link with an AP MLD, e.g., AP MLD 131, during a Transmit Opportunity (TxOP), e.g., as described below.

In some demonstrative aspects, the unavailability signaling information may be configured to signal whether or not the unavailability state is to be set for one or more second links between the non-AP MLD 151, and the AP MLD, e.g., AP MLD 131, during the TxOP, e.g., as described below.

In some demonstrative aspects, controller 154 may be configured to control, trigger, cause, and/or instruct the non-AP MLD 151 implemented by device 140 to transmit a frame including the unavailability signaling information to the AP MLD, e.g., AP MLD 131, over the first link during the TxOP, e.g., as described below.

In some demonstrative aspects, the first link may be in a first frequency band, and at least one link of the one or more second links may be in a second frequency band different from the first frequency band, e.g., as described below.

In one example, the first link may be in the 2.4 GHz band, and the one or more second links may include one or more links in the 5 GHz band, one or more links in the 6 GHz band, and/or one or more links in the mmWave band.

In another example, the first link may be in the 5 GHz band, and the one or more second links may include one or more links in the 2.4 GHz band, one or more links in the 6 GHz band, and/or one or more links in the mmWave band.

In some demonstrative aspects, the first link and at least one link of the one or more second links may be in a same frequency band, e.g., as described below.

In one example, the first link may be in the 2.4 GHz band, and one or more, e.g., some or all, of the one or more second links may also be in the 2.4 GHz band.

In another example, the first link may be in the 5 GHz band, and one or more, e.g., some or all, of the one or more second links may also be in the 5 GHz band.

In some demonstrative aspects, controller 154 may be configured to control, trigger, cause, and/or instruct the non-AP MLD implemented 151 by device 140 to transmit the frame from a non-AP STA of the non-AP MLD 151, e.g., non-AP STA 155, in a role of a TxOP holder of the TxOP, e.g., as described below.

In some demonstrative aspects, the frame including the unavailability signaling information may include an Initial Control Frame (ICF), e.g., as described below. In other aspects, the frame including the unavailability signaling information may include any other suitable type of frame.

In some demonstrative aspects, controller 154 may be configured to control, trigger, cause, and/or instruct the non-AP MLD 151 implemented by device 140 to transmit the frame from a non-AP STA of the non-AP MLD 151, e.g., non-AP STA 155, in a role of a TxOP responder of the TxOP, e.g., as described below.

In some demonstrative aspects, the frame including the unavailability signaling information may include an ICF response (also referred to as Initial Control Response (ICR)”), or a Block Acknowledgement (BA). In other aspects, the frame including the unavailability signaling information may include any other suitable type of frame.

In some demonstrative aspects, controller 154 may be configured to control, trigger, cause, and/or instruct the non-AP MLD 151 implemented by device 140 to configure the unavailability signaling information to signal whether or not the unavailability state is to be set for all links between the non-AP MLD 151 and the AP MLD, e.g., AP MLD 131, e.g., as described below.

In some demonstrative aspects, controller 154 may be configured to control, trigger, cause, and/or instruct the non-AP MLD 151 implemented by device 140 to configure the unavailability signaling information to signal whether or not the unavailability state is to be set for all links between the non-AP MLD 151 and the AP MLD, e.g., AP MLD 131, for example, which are in a same frequency band as the first link, e.g., as described below.

In some demonstrative aspects, controller 154 may be configured to control, trigger, cause, and/or instruct the non-AP MLD 151 implemented by device 140 to set the unavailability signaling information including, for example, an MLD-unavailability bit, which may be configured to signal whether or not the unavailability state is to be set for all links between the non-AP MLD 151 and the AP MLD, e.g., AP MLD 131, e.g., as described below.

In some demonstrative aspects, controller 154 may be configured to control, trigger, cause, and/or instruct the non-AP MLD 151 implemented by device 140 to set the MLD-unavailability bit to signal whether the unavailability state is to be set as an MLD-level (MLD-specific) unavailability, or as a STA-level (STA-specific) unavailability, e.g., as described below.

In some demonstrative aspects, controller 154 may be configured to control, trigger, cause, and/or instruct the non-AP MLD 151 implemented by device 140 to set the MLD-unavailability bit to “1”, for example, based on a determination that the unavailability state is to be set for all links between the non-AP MLD 151 and the AP MLD, e.g., AP MLD 131, e.g., as described below.

In some demonstrative aspects, controller 154 may be configured to control, trigger, cause, and/or instruct the non-AP MLD 151 implemented by device 140 to set the MLD-unavailability bit to “0”, for example, based on a determination that the unavailability state is not to be set for all links between the non-AP MLD 151 and the AP MLD, e.g., AP MLD 131, e.g., as described below.

In some demonstrative aspects, controller 154 may be configured to control, trigger, cause, and/or instruct the non-AP MLD 151 implemented by device 140 to configure the unavailability signaling information to include a bitmap, which may include a plurality of bits corresponding to a plurality of links, e.g., as described below.

In some demonstrative aspects, a setting of a bit of the plurality of bits in the bitmap may be configured, for example, to signal whether or not the unavailability state is to be set for a link corresponding to the bit, e.g., as described below.

In some demonstrative aspects, controller 154 may be configured to control, trigger, cause, and/or instruct the non-AP MLD 151 implemented by device 140 to set the unavailability signaling information to include, for example, one or more link Identifiers (IDs) of one or more respective links for which the unavailability state is to be set, e.g., as described below.

In some demonstrative aspects, controller 154 may be configured to control, trigger, cause, and/or instruct the non-AP MLD 151 implemented by device 140 to process capability information from the AP MLD, e.g., AP MLD 131, for example, to identify a processing delay time for processing the unavailability signaling information, e.g., as described below.

In some demonstrative aspects, controller 154 may be configured to control, trigger, cause, and/or instruct the non-AP MLD 151 implemented by device 140 to configure the unavailability signaling information, for example, based on the processing delay time, e.g., as described below.

In some demonstrative aspects, controller 154 may be configured to control, trigger, cause, and/or instruct the non-AP MLD 151 implemented by device 140 to set the unavailability signaling information to include, for example, unavailability reason information to signal a reason for setting the unavailability state, e.g., as described below.

In some demonstrative aspects, controller 154 may be configured to control, trigger, cause, and/or instruct the non-AP MLD 151 implemented by device 140 to set the unavailability reason information, for example, to signal that the unavailability state over the first link is due to an EMLSR constraint, e.g., as described below.

In some demonstrative aspects, controller 154 may be configured to control, trigger, cause, and/or instruct the non-AP MLD 151 implemented by device 140 to set the unavailability reason information, for example, to signal that the unavailability state over the first link is to truncate a downlink transmission from the AP MLD, e.g., the AP MLD 131, to the non-AP MLD 151 over the first link, for example, in order to allow an uplink transmission from the non-AP MLD 151 to the AP MLD, e.g., AP MLD 131, over a second link during the TxOP, e.g., as described below.

In some demonstrative aspects, a channel bandwidth of the second link, e.g., to be used for the uplink transmission, may be wider than a channel bandwidth of the first link, e.g., used for the downlink transmission, e.g., as described below.

In some demonstrative aspects, controller 154 may be configured to control, trigger, cause, and/or instruct the non-AP MLD 151 implemented by device 140 to configure the unavailability signaling information, for example, to signal a timing during the TxOP at which the unavailability state is to be applied, e.g., as described below.

In some demonstrative aspects, controller 154 may be configured to control, trigger, cause, and/or instruct the non-AP MLD 151 implemented by device 140 to configure the unavailability signaling information, for example, to signal a time duration in which the unavailability state is to be applied, e.g., as described below.

In some demonstrative aspects, controller 154 may be configured to control, trigger, cause, and/or instruct the non-AP MLD 151 implemented by device 140 to transmit a ML element to an AP MLD, e.g., AP MLD 131, for example, during setup of a ML connection between the non-AP MLD 151 and the AP MLD, e.g., as described below.

In some demonstrative aspects, controller 154 may be configured to control, trigger, cause, and/or instruct the non-AP MLD 151 implemented by device 140 to configure the ML element to include availability/unavailability link-dependency signaling information to signal a setting dependency between a first link and one or more second links, e.g., as described below.

In some demonstrative aspects, the setting dependency may include, for example, a dependency of a setting of an availability/unavailability state of the one or more second links on a setting of an availability/unavailability state of the first link, e.g., as described below.

In some demonstrative aspects, controller 154 may be configured to control, trigger, cause, and/or instruct the non-AP MLD 151 implemented by device 140 to transmit a frame to the AP MLD during a TxOP, e.g., as described below.

In some demonstrative aspects, controller 154 may be configured to control, trigger, cause, and/or instruct the non-AP MLD 151 implemented by device 140 to configure the frame to include unavailability signaling information to signal an unavailability state at which the non-AP MLD 151 is to be unavailable for communication over the first link with the AP MLD, e.g., AP MLD 131, during the TxOP, e.g., as described below.

In some demonstrative aspects, controller 154 may be configured to control, trigger, cause, and/or instruct the non-AP MLD 151 implemented by device 140 to set the availability/unavailability state of the one or more second links for communication with the AP MLD during the TxOP according to the setting dependency, e.g., as described below.

In some demonstrative aspects, the first link may be in a first frequency band, and at least one link of the one or more second links may be in a second frequency band different from the first frequency band, e.g., as described below.

In one example, the first link may be in the 2.4 GHz band, and the one or more second links may include one or more links in the 5 GHz band, one or more links in the 6 GHz band, and/or one or more links in the mmWave band.

In another example, the first link may be in the 5 GHz band, and the one or more second links may include one or more links in the 2.4 GHz band, one or more links in the 6 GHz band, and/or one or more links in the mmWave band.

In some demonstrative aspects, the first link and at least one link of the one or more second links may be in a same frequency band, e.g., as described below.

In one example, the first link may be in the 2.4 GHz band, and one or more, e.g., some or all, of the one or more second links may also be in the 2.4 GHz band.

In another example, the first link may be in the 5 GHz band, and one or more, e.g., some or all, of the one or more second links may also be in the 5 GHz band.

In some demonstrative aspects, controller 154 may be configured to control, trigger, cause, and/or instruct the non-AP MLD implemented 151 by device 140 to transmit the frame from a non-AP STA of the non-AP MLD 151, e.g., non-AP STA 155, in a role of a TxOP holder of the TxOP, e.g., as described below.

In some demonstrative aspects, the frame including the unavailability signaling information may include an ICF, e.g., as described below. In other aspects, the frame including the unavailability signaling information may include any other suitable type of frame.

In some demonstrative aspects, controller 154 may be configured to control, trigger, cause, and/or instruct the non-AP MLD 151 implemented by device 140 to transmit the frame from a non-AP STA of the non-AP MLD 151, e.g., non-AP STA 155, in a role of a TxOP responder of the TxOP, e.g., as described below.

In some demonstrative aspects, the frame including the unavailability signaling information may include an ICF response, or a BA. In other aspects, the frame including the unavailability signaling information may include any other suitable type of frame.

In some demonstrative aspects, controller 154 may be configured to control, trigger, cause, and/or instruct the non-AP MLD 151 implemented by device 140 to configure the availability/unavailability link-dependency signaling information to signal, for example, whether or not the unavailability state is to be set for all links between the non-AP MLD 151 and the AP MLD when the unavailability state is to be set for the first link, e.g., as described below.

In some demonstrative aspects, controller 154 may be configured to control, trigger, cause, and/or instruct the non-AP MLD 151 implemented by device 140 to configure the availability/unavailability link-dependency signaling information to signal, for example, whether or not the unavailability state is to be set for all links between the non-AP MLD 151 and the AP MLD, which are in a same frequency band as the first link, when the unavailability state is to be set for the first link, e.g., as described below.

In some demonstrative aspects, controller 154 may be configured to control, trigger, cause, and/or instruct the non-AP MLD 151 implemented by device 140 to set the availability/unavailability link-dependency signaling information to include, for example, an MLD-unavailability bit, which may be configured, for example, to signal whether or not the unavailability state is to be set for all links between the non-AP MLD 151 and the AP MLD when the unavailability state is to be set for the first link, e.g., as described below.

In some demonstrative aspects, controller 154 may be configured to control, trigger, cause, and/or instruct the non-AP MLD 151 implemented by device 140 to set the MLD-unavailability bit to “1”, for example, based on a determination that the unavailability state is to be set for all links between the non-AP MLD 151 and the AP MLD when the unavailability state is to be set for the first link, e.g., as described below.

In some demonstrative aspects, controller 154 may be configured to control, trigger, cause, and/or instruct the non-AP MLD 151 implemented by device 140 to set the MLD-unavailability bit to “0”, for example, based on a determination that the unavailability state is not to be set for all links between the non-AP MLD 151 and the AP MLD when the unavailability state is to be set for the first link, e.g., as described below.

In some demonstrative aspects, controller 154 may be configured to control, trigger, cause, and/or instruct the non-AP MLD 151 implemented by device 140 to configure the unavailability signaling information, for example, to signal a timing during the TxOP at which the unavailability state is to be applied, e.g., as described below.

In some demonstrative aspects, controller 154 may be configured to control, trigger, cause, and/or instruct the non-AP MLD 151 implemented by device 140 to configure the unavailability signaling information, for example, to signal a time duration during the TxOP in which the unavailability state is to be applied, e.g., as described below.

In some demonstrative aspects, device 102 and/or device 140 may be configured to perform one or more operations and/or functionalities of an MLD unavailability mechanism, which may be configured to signal an unavailability state for a non-AP MLD, e.g., non-AP MLD 151, over one or more links between the non-AP MLD and an AP MLD, e.g., as describe below.

In some demonstrative aspects, it may be defined that a STA of a non-AP MLD may be allowed to signal different unavailability information for different links, e.g., as described below.

In one example, a STA of a non-AP MLD may indicate unavailability in a 2.4 GHz link, and to indicate that the non-AP MLD is to be available for operation on one or more other links, for example, on any 5 GHz link and/or any 6 GHz link.

In another example, a STA of a non-AP MLD may indicate unavailability on a 5 GHz link or a 6 GHz link, and to indicate that the non-AP MLD is to be unavailable for operation also on another 5 GHz link and/or another 6 GHz link, for example, due to in-device interference.

In some demonstrative aspects, it may be defined that availability/unavailability information for the non-AP MLD may itself be carried in a short-term signaling to the AP MLD, for example, in an ICR or an ICF, e.g., as described below.

In some demonstrative aspects, it may be defined that the non-AP MLD may signal its simultaneous availability/unavailability on different links, for example, during ML setup, e.g., during the ML setup performed between the non-AP MLD and the AP MLD.

In some demonstrative aspects, it may be defined that the non-AP MLD may configure an ML element to include availability/unavailability information (also referred to as “availability/unavailability link-dependency signaling information”), which may be configured to signal its simultaneous availability/unavailability on a plurality of different links.

For example, it may be defined that the non-AP MLD may transmit the ML element as part of one or more frames, which may be transmitted from the non-AP MLD to an AP MLD, for example, during setup of a ML connection between the non-AP MLD and the AP MLD.

In one example, the non-AP MLD may configure the simultaneous availability/unavailability information, for example, to signal that when the non-AP MLD will not be able to operate, e.g., is to be unavailable, over a link in a particular frequency band, then the non-AP MLD will not be able to operate, e.g., is to be unavailable, over at least one other link, e.g., some or all other links, in the same particular frequency band.

In another example, the non-AP MLD may configure the simultaneous availability/unavailability information, for example, to signal that when the non-AP MLD will not be able to operate, e.g., is to be unavailable, over a link in a particular frequency band, then the non-AP MLD will be able to operate, e.g., is to be available, over at least one other link in another frequency band. For example, the non-AP MLD may configure the simultaneous availability/unavailability information, for example, to signal that the non-AP MLD can operate in a 5 GHz link, for example, when a 2.4 GHz link is unavailable.

In another example, the non-AP MLD may configure the simultaneous availability/unavailability information, for example, to signal that the non-AP MLD will not be able to operate, e.g., is to be unavailable, over a link in a particular frequency band, for example, when the non-AP ML is to operate, e.g., to be available, over at least one other link in another frequency band. For example, the non-AP MLD may configure the simultaneous availability/unavailability information, for example, to signal that the non-AP MLD cannot operate on a 5 GHz link, for example, when operating on a 6 GHz link.

In another example, the non-AP MLD may configure the simultaneous availability/unavailability information, for example, to signal that when the non-AP MLD will not be able to operate, e.g., is to be unavailable, over a link in a particular frequency band, then the non-AP MLD will be able to operate, e.g., is to be available, over at least one other link in the same particular frequency band. For example, the non-AP MLD may configure the simultaneous availability/unavailability information, for example, to signal that when a first 5 GHz link is unavailable then another 5 GHz link may be available.

In other aspects, the simultaneous availability/unavailability information may be configured to indicate any other additional or alternative type of dependencies and/or relationships between a plurality of links of the non-AP MLD.

In some demonstrative aspects, the simultaneous availability/unavailability information may be signaled as part of an ML element, for example, using a bitmap, which may be configured to signal the availability/unavailability dependencies for the different links.

In one example, the bitmap may be configured, for example, in accordance with a design of a non-Simultaneous Transmit and Receive (NSTR) bitmap signaling, e.g., in accordance with an IEEE 802.11be Specification.

In some demonstrative aspects, it may be defined that the AP MLD may, e.g., should, consider the information shared by the non-AP MLD during the ML setup, for example, in order to determine the availability of one or more non-AP STAs of the non-AP MLD on one or more links during a TxOP.

In some demonstrative aspects, it may be defined that the AP MLD may, e.g., should, process a frame received from the non-AP MLD during a TxOP over a given link, for example, to identify unavailability signaling information from the non-AP MLD.

In some demonstrative aspects, it may be defined that the AP MLD may, e.g., should, process the unavailability signaling information from the non-AP MLD, for example, to identify an unavailability state at which the non-AP MLD is to be unavailable for communication over the given link with the AP MLD during the TxOP.

In some demonstrative aspects, it may be defined that the AP MLD may, e.g., should, determine the availability/unavailability state of one or more second links for communication with the non-AP MLD during the TxOP, for example, based on the determination of the unavailability state of the non-AP MLD over the given link, and based on the simultaneous availability/unavailability information signaled by the non-AP MLD during the ML setup.

For example, during operation, based on the non-AP STA of the non-AP MLD indicating availability/unavailability on a given link, the AP MLD would consider the availability/unavailability link-dependency signaling information shared by the non-AP MLD during ML setup, for example, to determine the availability/unavailability of the non-AP MLD, e.g., one or more non-AP STAs of the non-AP MLD, on other links.

In some demonstrative aspects, it may be defined that a particular bit (also referred to as “MLD-unavailability bit” or “STA-level/MLD-level availability bit”) is to be configured to support a differentiation for signaling between STA-level short-term availability, e.g., where the availability/unavailability signaling is to be applied to at least one particular STA and/or link, and MLD level short-term availability, e.g., where the availability/unavailability signaling is to be applied to all STAs and/or links of the non-AP MLD.

For example, it may be defined that the non-AP MLD is to include the STA-level/MLD-level availability bit in a frame that carries the availability/unavailability signaling information.

For example, it may be defined that the non-AP MLD is to set availability/unavailability signaling information in a frame, and to set the MLD-unavailability bit in the frame to indicate whether the availability/unavailability signaling information in the frame is to be applied for a STA-level short-term availability or for a MLD-level short-term availability.

For example, the MLD-unavailability bit may be set to “1” to indicate the MLD-level unavailability.

For example, the MLD-unavailability bit may be set to “0” to indicate the STA-level unavailability.

For example, it may be defined that the non-AP MLD is to set the availability/unavailability signaling information in an ICF, for example, in case the frame is to be transmitted during the TxOP by a non-AP STA of the non-AP MLD in the role of the TxOP holder.

For example, it may be defined that the non-AP MLD is to set the availability/unavailability signaling information in an ICR or a BA, for example, in case the frame is to be transmitted during the TxOP by a non-AP STA of the non-AP MLD in the role of the TxOP responder.

In some demonstrative aspects, it may be defined that the STA-level unavailability signaling in a frame transmitted over a particular link may be configured to signal unavailability for another link used by the non-AP MLD. This may be achieved, for example, by adding a link ID (linkID) to the unavailability signaling.

For example, it may be defined that the non-AP MLD is to set the unavailability signaling information, which is to be transmitted over a particular link, to include one or more link Identifiers (IDs) of one or more respective links for which the unavailability state is to be set.

In some demonstrative aspects, it may be defined that the AP MLD is to advertise the time (also referred to as “processing delay time”), denoted T, e.g., in units of microseconds (us), that it takes to process an unavailability signaling received on a particular link (“link A”) for an unavailability event on a second link (“link B”).

For example, it may be defined that an AP may signal the processing delay time in one or more frames, for example, one or more management (Mgt) frames.

In one example, the AP MLD may transmit processing delay time information to signal the processing delay time, for example, in a broadcast Mgt frame or a unicast Mgt frame communicated between an AP of the AP MLD and a non-AP STA of the non-AP MLD.

In one example, the AP MLD may transmit the processing delay time information as part of capability information, which may be included, for example, in a capability field and/or a capability element, or the like.

In some demonstrative aspects, it may be defined that the AP MLD is to determine a timing for applying the unavailability event according to the unavailability signaling, for example, based on the processing delay time.

For example, it may be defined that the AP of the AP MLD shall refrain from talking to the STA of the non-AP MLD on the link B for the signaled unavailability duration, which may begin, for example, after T us from receiving the unavailability signaling on the link A.

For example, it may be defined that the STA should take this processing delay time into consideration, for example, while deciding when to signal the unavailability indication, and/or while deciding on the behavior it would expect from the AP.

In some demonstrative aspects, it may be defined that a non-AP MLD transmitting the unavailability signaling information may include unavailability reason information in the unavailability signaling information, for example, to signal a reason for setting the unavailability state.

In some demonstrative aspects, it may be defined that the non-AP MLD may be allowed to set the unavailability reason information to signal, for example, that the unavailability state is due to an EMLSR constraint.

In other aspects, it may be defined that the non-AP MLD may be allowed to set the unavailability reason information to signal any other additional or alternative reason and/or constraint.

In some demonstrative aspects, it may be defined that the non-AP MLD may configure the unavailability signaling information to indicate that a short-term STA-specific unavailability is being set due, for example, to EMLSR constraints.

In some demonstrative aspects, it may be defined that the non-AP MLD may set the indication that the short-term STA-specific unavailability is due to EMLSR constraints, for example, in a field (“reason field”) that allows multiple values, which may be included in the frame that carries the short-term unavailability signaling.

In one example, this reason field may be required to be present, for example, only when the short-term unavailability is STA-specific. In other aspects, the reason field may be present, for example, in case the short-term unavailability is MLD-specific.

In one example, the reason field may be configured to include multiple bits, for example, to provide a technical solution to support signaling of one or more other unavailability constraints.

In one example, one of the values of the reason field could be used to signal EMLSR constraints, e.g., while one or more other values may be reserved.

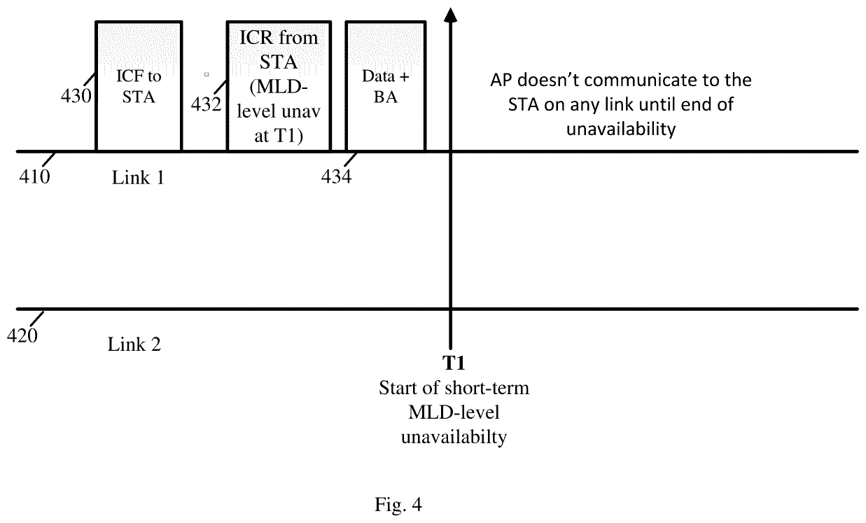

Reference is made to FIG. 4, which schematically illustrates communications between a non-AP MLD and an AP MLD, in accordance with some demonstrative aspects.

In one example, controller 154 (FIG. 1) may be configured to control, trigger, cause, and/or instruct the non-AP MLD 151 (FIG. 1) implemented by device 140 (FIG. 1) to perform one or more operations of, and/or to communicate one or more communications of, the non-AP MLD of FIG. 4; and/or controller 124 (FIG. 1) may be configured to control, trigger, cause, and/or instruct the AP MLD 131 (FIG. 1) implemented by device 102 (FIG. 1) to perform one or more operations of, and/or to communicate one or more communications of, the AP MLD of FIG. 4.

In some demonstrative aspects, as shown in FIG. 4, the non-AP MLD and the AP MLD may setup an ML connection over a first link 410 (link 1) and a second link 420 (link 2).

In some demonstrative aspects, as shown in FIG. 4, an AP of the AP MLD may transmit an ICF 430 to a non-AP STA of the non-AP MLD over the link 410, for example, during a TxOP, for example, in case the AP operates in a role of a TxOP holder.

In some demonstrative aspects, as shown in FIG. 4, the non-AP STA of the non-AP MLD may transmit an ICR 432 to the AP over the link 410, e.g., in response to the ICF 430, for example, in case the non-AP STA operates in a role of a TxOP responder.

In some demonstrative aspects, as shown in FIG. 4, the non-AP STA of the non-AP MLD may set unavailability signaling information in the ICR 432, for example, to indicate that the non-AP MLD is to set an unavailability state at a particular time (T1) during the TxOP. For example, the non-AP STA of the non-AP MLD may set unavailability signaling information in the ICR 432 to indicate a time duration of the unavailability state, e.g., beginning at the time T1.

In some demonstrative aspects, as shown in FIG. 4, the non-AP STA of the non-AP MLD may set the unavailability signaling information in the ICR 432, for example, to indicate that the unavailability state is to be set as an MLD-level unavailability state, e.g., for all links between the non-AP MLD and the AP MLD. In one example, the non-AP STA may set the MLD-unavailability bit to “1” to indicate the MLD-level unavailability state, e.g., as described above.

In some demonstrative aspects, as shown in FIG. 4, the AP MLD may communicate one or more transmissions 434 with the non-AP MLD, e.g., a data transmission and a corresponding BA, for example, over the link 410, for example, following the ICR 432 and before the time T1.

In some demonstrative aspects, as shown in FIG. 4, the non-AP MLD may begin a short-term unavailability state at the time T1, at which the non-AP MLD may be unavailable, for example, at the MLD-level, e.g., over both the link 410 and the link 420, for example, during an unavailability duration beginning at the time T1.

In some demonstrative aspects, as shown in FIG. 4, the AP MLD may refrain from communicating with the non-AP MLD over any of the links 410 and 420, for example, during the unavailability duration beginning at the time T1.

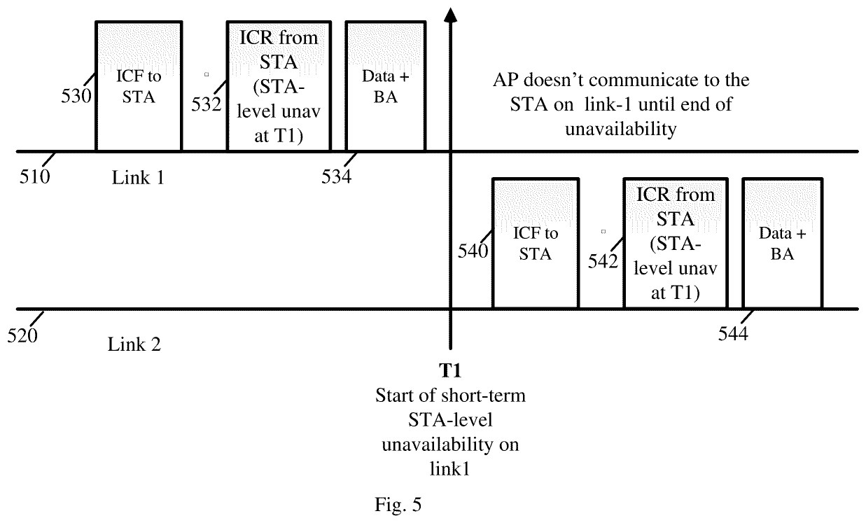

Reference is made to FIG. 5, which schematically illustrates communications between a non-AP MLD and an AP MLD, in accordance with some demonstrative aspects.

In one example, controller 154 (FIG. 1) may be configured to control, trigger, cause, and/or instruct the non-AP MLD 151 (FIG. 1) implemented by device 140 (FIG. 1) to perform one or more operations of, and/or to communicate one or more communications of, the non-AP MLD of FIG. 5; and/or controller 124 (FIG. 1) may be configured to control, trigger, cause, and/or instruct the AP MLD 131 (FIG. 1) implemented by device 102 (FIG. 1) to perform one or more operations of, and/or to communicate one or more communications of, the AP MLD of FIG. 5.

In some demonstrative aspects, as shown in FIG. 5, the non-AP MLD and the AP MLD may setup an ML connection over a first link 510 (link 1) and a second link 520 (link 2).

In some demonstrative aspects, as shown in FIG. 5, an AP of the AP MLD may transmit an ICF 530 to a non-AP STA of the non-AP MLD over the link 510, for example, during a TxOP, for example, in case the AP operates in a role of a TxOP holder.

In some demonstrative aspects, as shown in FIG. 5, the non-AP STA of the non-AP MLD may transmit an ICR 532 to the AP over the link 510, e.g., in response to the ICF 530, for example, in case the non-AP STA operates in a role of a TxOP responder.

In some demonstrative aspects, as shown in FIG. 5, the non-AP STA of the non-AP MLD may set unavailability signaling information in the ICR 532, for example, to indicate that the non-AP MLD is to set an unavailability state at a particular time (T1) during the TxOP. For example, the non-AP STA of the non-AP MLD may set unavailability signaling information in the ICR 532 to indicate a time duration of the unavailability state, e.g., beginning at the time T1.

In some demonstrative aspects, as shown in FIG. 5, the non-AP STA of the non-AP MLD may set the unavailability signaling information in the ICR 532, for example, to indicate that the unavailability state is to be set as a STA-level unavailability state, e.g., to be applied for the particular link 510 between the non-AP MLD and the AP MLD. In one example, the non-AP STA may set the MLD-unavailability bit to “0” to indicate the STA-level unavailability state, e.g., as described above.

In some demonstrative aspects, as shown in FIG. 5, the AP MLD may communicate one or more transmissions 534 with the non-AP MLD, e.g., a data transmission and a corresponding BA, for example, over the link 510, for example, following the ICR 532 and before the time T1.

In some demonstrative aspects, as shown in FIG. 5, the non-AP MLD may begin a short-term unavailability state at the time T1, for example, at the STA-level, e.g., over the link 510, for example, during an unavailability duration beginning at the time T1. For example, as shown in FIG. 5, the non-AP MLD may remain available over the link 520, for example, during the unavailability duration beginning at the time T1.

In some demonstrative aspects, as shown in FIG. 5, the AP MLD may refrain from communicating with the non-AP MLD over the link 510, for example, during the unavailability duration beginning at the time T1.

In some demonstrative aspects, as shown in FIG. 5, the AP MLD may be allowed to communicate with the non-AP MLD over the link 520, for example, during the unavailability duration beginning at the time T1. For example, as shown in FIG. 5, the AP MLD may transmit an ICF 540 to the non-AP MLD over the link 520, the non-AP MLD may transmit an ICR 542 to the non-AP over the link 520, e.g., in response to the ICF 540, and the AP MLD and non-AP MLD may exchange transmissions 544, e.g., a data frame and a corresponding BA, over the link 520.

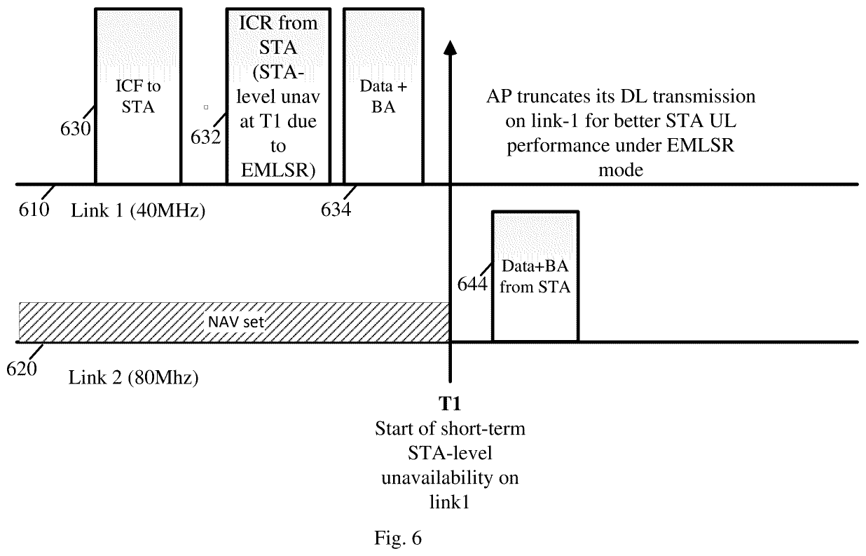

Reference is made to FIG. 6, which schematically illustrates communications between a non-AP MLD and an AP MLD, in accordance with some demonstrative aspects.

In one example, controller 154 (FIG. 1) may be configured to control, trigger, cause, and/or instruct the non-AP MLD 151 (FIG. 1) implemented by device 140 (FIG. 1) to perform one or more operations of, and/or to communicate one or more communications of, the non-AP MLD of FIG. 6; and/or controller 124 (FIG. 1) may be configured to control, trigger, cause, and/or instruct the AP MLD 131 (FIG. 1) implemented by device 102 (FIG. 1) to perform one or more operations of, and/or to communicate one or more communications of, the AP MLD of FIG. 6.

In some demonstrative aspects, as shown in FIG. 6, the non-AP MLD and the AP MLD may setup an ML connection over a first link 610 (link 1) and a second link 620 (link 2).

In some demonstrative aspects, as shown in FIG. 6, the ML connection may be setup according to an EMLSR mode, for example, where the link 610 may be utilized as a DL, and the link 620 may be utilized as an UL.

For example, as shown in FIG. 6, the link 610 may have a BW, e.g., 40 MHz, which may be narrower than a BW, e.g., 80 MHz, of the link 620.

In some demonstrative aspects, as shown in FIG. 6, an AP of the AP MLD may transmit an ICF 630 to a non-AP STA of the non-AP MLD over the link 610, for example, during a TxOP, for example, in case the AP operates in a role of a TxOP holder.

In some demonstrative aspects, as shown in FIG. 6, the non-AP STA of the non-AP MLD may transmit an ICR 632 to the AP over the link 610, e.g., in response to the ICF 630, for example, in case the non-AP STA operates in a role of a TxOP responder.

In some demonstrative aspects, as shown in FIG. 6, the non-AP STA of the non-AP MLD may set unavailability signaling information in the ICR 632, for example, to indicate that the non-AP MLD is to set an unavailability state at a particular time (T1) during the TxOP. For example, the non-AP STA of the non-AP MLD may set unavailability signaling information in the ICR 632 to indicate a time duration of the unavailability state, e.g., beginning at the time T1.

In some demonstrative aspects, as shown in FIG. 6, the non-AP STA of the non-AP MLD may set the unavailability signaling information in the ICR 632, for example, to indicate that the unavailability state is to be set as a STA-level unavailability state, e.g., to be applied for the particular link 610 between the non-AP MLD and the AP MLD. In one example, the non-AP STA may set the MLD-unavailability bit to “0” to indicate the STA-level unavailability state, e.g., as described above.

In some demonstrative aspects, as shown in FIG. 6, the non-AP STA of the non-AP MLD may set the unavailability signaling information in the ICR 632, for example, to indicate that the STA-level unavailability state is due to an EMLSR constraint, e.g., as described above.

In some demonstrative aspects, as shown in FIG. 6, the AP MLD may communicate one or more transmissions 634 with the non-AP MLD, e.g., a data transmission and a corresponding BA, for example, over the link 610, for example, following the ICR 632 and before the time T1.

In some demonstrative aspects, as shown in FIG. 6, the AP MLD may truncate the DL transmission period over the link 610, e.g., at the time T1, for example, to allow the non-AP MLD to transmit one or more UL data transmissions 644 over the link 620.

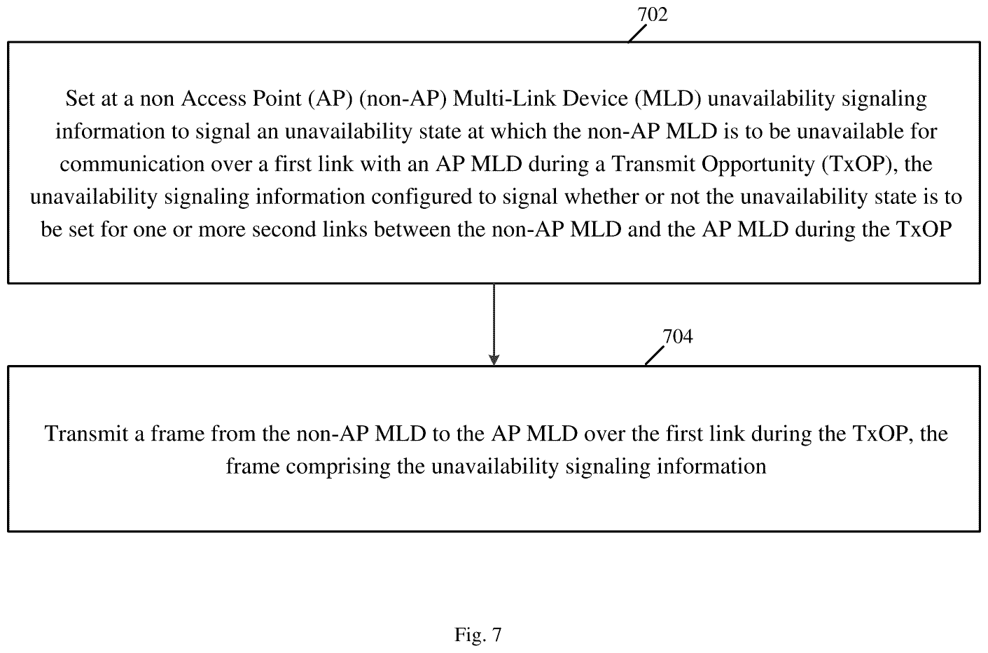

Reference is made to FIG. 7, which schematically illustrates a method of unavailability state of an MLD, in accordance with some demonstrative aspects. For example, one or more of the operations of the method of FIG. 7 may be performed by one or more elements of a system, e.g., system 100 (FIG. 1), for example, one or more wireless devices, e.g., device 102 (FIG. 1) and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 702, the method may include setting at a non-AP MLD unavailability signaling information to signal an unavailability state at which the non-AP MLD is to be unavailable for communication over a first link with an AP MLD, for example during a TxOP. For example, the unavailability signaling information may be configured to signal whether or not the unavailability state is to be set for one or more second links between the non-AP MLD and the AP MLD during the TxOP. For example, controller 154 (FIG. 1) may be configured to cause, trigger, instruct, and/or control a non-AP MLD 151 (FIG. 1) implemented by device 140 (FIG. 1) to set the unavailability signaling information to signal the unavailability state at which the non-AP MLD 151 (FIG. 1) is to be unavailable for communication over the first link, and to signal whether or not the unavailability state is to be set for one or more second links between the non-AP MLD 151 (FIG. 1) and the AP MLD 131 (FIG. 1) during the TxOP, e.g., as described above.

As indicated at block 704, the method may include transmitting a frame including the unavailability signaling information to the AP MLD over the first link during the TxOP. For example, controller 154 (FIG. 1) may be configured to cause, trigger, instruct, and/or control the non-AP MLD 151 (FIG. 1) implemented by device 140 (FIG. 1) to transmit the frame including the unavailability signaling information to the AP MLD 131 (FIG. 1) over the first link during the TxOP, e.g., as described above.

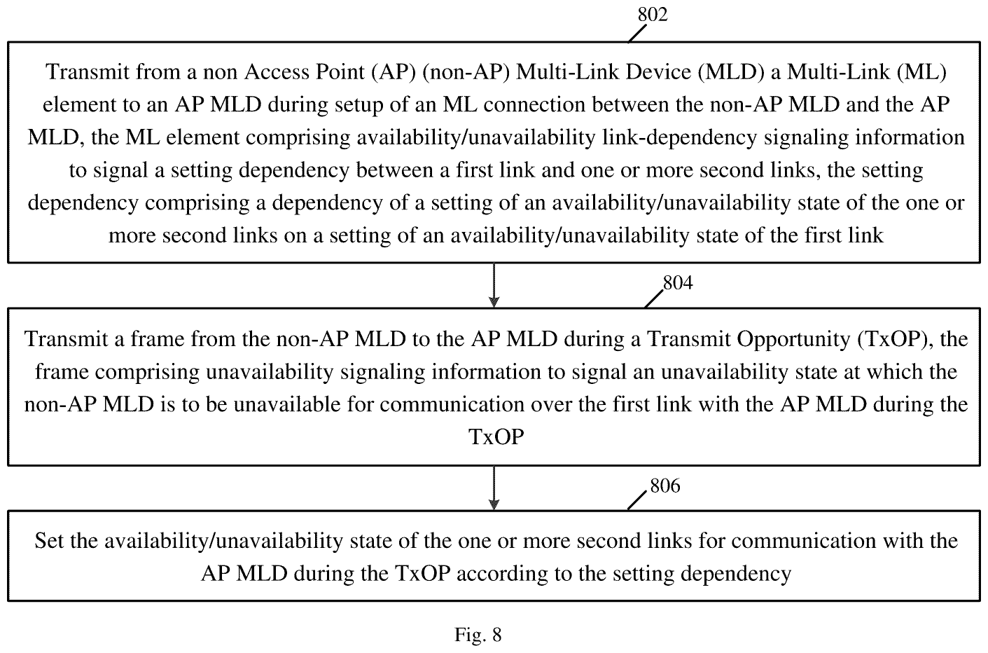

Reference is made to FIG. 8, which schematically illustrates a method of unavailability state of an MLD, in accordance with some demonstrative aspects. For example, one or more of the operations of the method of FIG. 8 may be performed by one or more elements of a system, e.g., system 100 (FIG. 1), for example, one or more wireless devices, e.g., device 102 (FIG. 1) and/or device 140 (FIG. 1), an MLD, e.g., MLD 131 (FIG. 1) and/or MLD 151 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 802, the method may include transmitting an ML element from a non-AP MLD to an AP MLD during setup of an ML connection between the non-AP MLD and the AP MLD. For example, the ML element may include availability/unavailability link-dependency signaling information to signal a setting dependency between a first link and one or more second links. For example, the setting dependency may include a dependency of a setting of an availability/unavailability state of the one or more second links on a setting of an availability/unavailability state of the first link. For example, controller 154 (FIG. 1) may be configured to cause, trigger, instruct, and/or control a non-AP MLD 151 (FIG. 1) implemented by device 140 (FIG. 1) to transmit the ML element including the availability/unavailability link-dependency signaling information to the AP MLD 131 (FIG. 1), for example, during the setup of the ML connection between the non-AP MLD 151 (FIG. 1) and the AP MLD 131 (FIG. 1), e.g., as described above.

As indicated at block 804, the method may include transmitting a frame from the non-AP MLD to the AP MLD during a TxOP. For example, the frame may include unavailability signaling information to signal an unavailability state at which the non-AP MLD is to be unavailable for communication over the first link with the AP MLD during the TxOP. For example, controller 154 (FIG. 1) may be configured to cause, trigger, instruct, and/or control the non-AP MLD 151 (FIG. 1) implemented by device 140 (FIG. 1) to transmit the frame including the unavailability signaling information to the AP MLD 131 (FIG. 1) during the TxOP, e.g., as described above.

As indicated at block 806, the method may setting the availability/unavailability state of the one or more second links for communication with the AP MLD during the TxOP according to the setting dependency. For example, controller 154 (FIG. 1) may be configured to cause, trigger, instruct, and/or control the non-AP MLD 151 (FIG. 1) implemented by device 140 (FIG. 1) to set the availability/unavailability state of the one or more second links for communication with the AP MLD 131 (FIG. 1) during the TxOP, for example, according to the setting dependency signaled by the availability/unavailability link-dependency signaling information in the ML element during the setup of the ML connection, e.g., as described above.

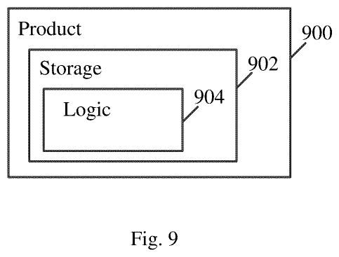

Reference is made to FIG. 9, which schematically illustrates a product of manufacture 900, in accordance with some demonstrative aspects. Product 900 may include one or more tangible computer-readable (“machine-readable”) non-transitory storage media 902, which may include computer-executable instructions, e.g., implemented by logic 904, operable to, when executed by at least one computer processor, enable the at least one computer processor to implement one or more operations at device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1); to cause device 102 (FIG. 1), device 140 (FIG. 1), MLD 131 (FIG. 1), MLD 151 (FIG. 1), radio 114 (FIG. 1), radio 144 (FIG. 1), transmitter 118 (FIG. 1), transmitter 148 (FIG. 1), receiver 116 (FIG. 1), receiver 146 (FIG. 1), message processor 128 (FIG. 1), message processor 158 (FIG. 1), controller 124 (FIG. 1), and/or controller 154 (FIG. 1), to perform, trigger and/or implement one or more operations and/or functionalities; and/or to perform, trigger and/or implement one or more operations and/or functionalities described with reference to the FIGS. 1-8, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 900 and/or machine readable storage media 902 may include one or more types of computer-readable storage media capable of storing data, including volatile memory, non-volatile memory, removable or non-removable memory, erasable or non-erasable memory, writeable or re-writeable memory, and the like. For example, machine readable storage media 902 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 904 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 904 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### EXAMPLES

The following examples pertain to further aspects.

Example 1 includes an apparatus comprising a processor configured to cause a non Access Point (AP) (non-AP) Multi-Link Device (MLD) to set unavailability signaling information to signal an unavailability state at which the non-AP MLD is to be unavailable for communication over a first link with an AP MLD during a Transmit Opportunity (TxOP), the unavailability signaling information configured to signal whether or not the unavailability state is to be set for one or more second links between the non-AP MLD and the AP MLD during the TxOP; and transmit a frame to the AP MLD over the first link during the TxOP, the frame comprising the unavailability signaling information; and a memory to store information processed by the processor.

Example 2 includes the subject matter of Example 1, and optionally, wherein the unavailability signaling information is configured to signal whether or not the unavailability state is to be set for all links between the non-AP MLD and the AP MLD.

Example 3 includes the subject matter of Example 1 or 2, and optionally, wherein the unavailability signaling information is configured to signal whether or not the unavailability state is to be set for all links between the non-AP MLD and the AP MLD, which are in a same frequency band as the first link.

Example 4 includes the subject matter of any one of Examples 1-3, and optionally, wherein the apparatus is configured to cause the non-AP MLD to set the unavailability signaling information comprising an MLD-unavailability bit configured to signal whether or not the unavailability state is to be set for all links between the non-AP MLD and the AP MLD.

Example 5 includes the subject matter of Example 4, and optionally, wherein the apparatus is configured to cause the non-AP MLD to set the MLD-unavailability bit to “1” based on a determination that the unavailability state is to be set for all links between the non-AP MLD and the AP MLD.

Example 6 includes the subject matter of any one of Examples 1-5, and optionally, wherein the first link is in a first frequency band, and at least one link of the one or more second links is in a second frequency band different from the first frequency band.

Example 7 includes the subject matter of any one of Examples 1-6, and optionally, wherein the first link and at least one link of the one or more second links are in a same frequency band.

Example 8 includes the subject matter of any one of Examples 1-7, and optionally, wherein the unavailability signaling information comprises a bitmap comprising a plurality of bits corresponding to a plurality of links, wherein a setting of a bit of the plurality of bits is to signal whether or not the unavailability state is to be set for a link corresponding to the bit.

Example 9 includes the subject matter of any one of Examples 1-8, and optionally, wherein the apparatus is configured to cause the non-AP MLD to set the unavailability signaling information comprising one or more link Identifiers (IDs) of one or more respective links for which the unavailability state is to be set.

Example 10 includes the subject matter of any one of Examples 1-9, and optionally, wherein the apparatus is configured to cause the non-AP MLD to process capability information from the AP MLD to identify a processing delay time for processing the unavailability signaling information, and to configure the unavailability signaling information based on the processing delay time.

Example 11 includes the subject matter of any one of Examples 1-10, and optionally, wherein the apparatus is configured to cause the non-AP MLD to set the unavailability signaling information comprising unavailability reason information to signal a reason for setting the unavailability state.

Example 12 includes the subject matter of Example 11, and optionally, wherein the apparatus is configured to cause the non-AP MLD to set the unavailability reason information to signal that the unavailability state over the first link is due to an Enhanced Multi Link Single Radio (EMLSR) constraint.

Example 13 includes the subject matter of Example 11 or 12, and optionally, wherein the apparatus is configured to cause the non-AP MLD to set the unavailability reason information to signal that the unavailability state over the first link is to truncate a downlink transmission from the AP MLD to the non-AP MLD over the first link in order to allow an uplink transmission from the non-AP MLD to the AP MLD over a second link during the TxOP.

Example 14 includes the subject matter of Example 13 wherein a channel bandwidth of the second link is wider than a channel bandwidth of the first link.

Example 15 includes the subject matter of any one of Examples 1-14, and optionally, wherein the unavailability signaling information is configured to signal a timing during the TxOP at which the unavailability state is to be applied.

Example 16 includes the subject matter of any one of Examples 1-15, and optionally, wherein the apparatus is configured to cause the non-AP MLD to transmit the frame from a non-AP STA of the non-AP MLD in a role of a TxOP holder of the TxOP.

Example 17 includes the subject matter of Example 16, and optionally, wherein the frame comprises an Initial Control Frame (ICF).

Example 18 includes the subject matter of any one of Examples 1-15, and optionally, wherein the apparatus is configured to cause the non-AP MLD to transmit the frame from a non-AP STA of the non-AP MLD in a role of a TxOP responder of the TxOP.

Example 19 includes the subject matter of Example 18, and optionally, wherein the frame comprises an Initial Control Frame (ICF) response, or a Block Acknowledgement (BA).

Example 20 includes the subject matter of any one of Examples 1-19, and optionally, comprising a radio to transmit the frame.

Example 21 includes the subject matter of Example 20, and optionally, comprising one or more antennas connected to the radio, and another processor to execute instructions of an operating system.

Example 22 includes an apparatus comprising a processor configured to cause a non Access Point (AP) (non-AP) Multi-Link Device (MLD) to transmit a Multi-Link (ML) element to an AP MLD during setup of an ML connection between the non-AP MLD and the AP MLD, the ML element comprising availability/unavailability link-dependency signaling information to signal a setting dependency between a first link and one or more second links, the setting dependency comprising a dependency of a setting of an availability/unavailability state of the one or more second links on a setting of an availability/unavailability state of the first link; transmit a frame to the AP MLD during a Transmit Opportunity (TxOP), the frame comprising unavailability signaling information to signal an unavailability state at which the non-AP MLD is to be unavailable for communication over the first link with the AP MLD during the TxOP; and set the availability/unavailability state of the one or more second links for communication with the AP MLD during the TxOP according to the setting dependency; and a memory to store information processed by the processor.

Example 23 includes the subject matter of Example 22, and optionally, wherein the availability/unavailability link-dependency signaling information is configured to signal whether or not the unavailability state is to be set for all links between the non-AP MLD and the AP MLD when the unavailability state is to be set for the first link.

Example 24 includes the subject matter of Example 22 or 23, and optionally, wherein the availability/unavailability link-dependency signaling information is configured to signal whether or not the unavailability state is to be set for all links between the non-AP MLD and the AP MLD, which are in a same frequency band as the first link, when the unavailability state is to be set for the first link.

Example 25 includes the subject matter of any one of Examples 22-24, and optionally, wherein the apparatus is configured to cause the non-AP MLD to set the availability/unavailability link-dependency signaling information comprising an MLD-unavailability bit configured to signal whether or not the unavailability state is to be set for all links between the non-AP MLD and the AP MLD when the unavailability state is to be set for the first link.

Example 26 includes the subject matter of Example 25, and optionally, wherein the apparatus is configured to cause the non-AP MLD to set the MLD-unavailability bit to “1” based on a determination that the unavailability state is to be set for all links between the non-AP MLD and the AP MLD when the unavailability state is to be set for the first link.

Example 27 includes the subject matter of any one of Examples 22-26, and optionally, wherein the first link is in a first frequency band, and at least one link of the one or more second links is in a second frequency band different from the first frequency band.

Example 28 includes the subject matter of any one of Examples 22-27, and optionally, wherein the first link and at least one link of the one or more second links are in a same frequency band.

Example 29 includes the subject matter of any one of Examples 22-28, and optionally, wherein the unavailability signaling information is configured to signal a timing during the TxOP at which the unavailability state is to be applied.

Example 30 includes the subject matter of any one of Examples 22-29, and optionally, wherein the apparatus is configured to cause the non-AP MLD to transmit the frame from a non-AP STA of the non-AP MLD in a role of a TxOP holder of the TxOP.

Example 31 includes the subject matter of Example 30, and optionally, wherein the frame comprises an Initial Control Frame (ICF).

Example 32 includes the subject matter of any one of Examples 22-29, and optionally, wherein the apparatus is configured to cause the non-AP MLD to transmit the frame from a non-AP STA of the non-AP MLD in a role of a TxOP responder of the TxOP.

Example 33 includes the subject matter of Example 32, and optionally, wherein the frame comprises an Initial Control Frame (ICF) response, or a Block Acknowledgement (BA).

Example 34 includes the subject matter of any one of Examples 22-33, and optionally, comprising a radio to transmit the frame.

Example 35 includes the subject matter of Example 34, and optionally, comprising one or more antennas connected to the radio, and another processor to execute instructions of an operating system.

Example 36 includes the subject matter of any one of Examples 22-35, and optionally, comprising the subject matter of any one of Examples 1-21.

Example 37 includes a wireless communication device comprising the apparatus of any of Examples 1-36.

Example 38 includes a mobile device comprising the apparatus of any of Examples 1-36.

Example 39 includes an apparatus comprising means for executing any of the described operations of any of Examples 1-36.

Example 40 includes a product comprising one or more tangible computer-readable non-transitory storage media comprising instructions operable to, when executed by at least one processor, enable the at least one processor to cause any of the described operations of any of Examples 1-36.

Example 41 includes an apparatus comprising: a memory interface; and processing circuitry configured to: perform any of the described operations of any of Examples 1-36.

Example 42 includes a method comprising any of the described operations of any of Examples 1-36.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising:
a processor configured to cause a non Access Point (AP) (non-AP) Multi-Link Device (MLD) to:
set unavailability signaling information to signal an unavailability state at which the non-AP MLD is to be unavailable for communication over a first link with an AP MLD during a Transmit Opportunity (TxOP), the unavailability signaling information configured to signal whether or not the unavailability state is to be set for one or more second links between the non-AP MLD and the AP MLD during the TxOP; and
transmit a frame to the AP MLD over the first link during the TxOP,
the frame comprising the unavailability signaling information; and
a memory to store information processed by the processor.

2. The apparatus of claim 1, wherein the unavailability signaling information is configured to signal whether or not the unavailability state is to be set for all links between the non-AP MLD and the AP MLD.

3. The apparatus of claim 1, wherein the unavailability signaling information is configured to signal whether or not the unavailability state is to be set for all links between the non-AP MLD and the AP MLD, which are in a same frequency band as the first link.

4. The apparatus of claim 1 configured to cause the non-AP MLD to set the unavailability signaling information comprising an MLD-unavailability bit configured to signal whether or not the unavailability state is to be set for all links between the non-AP MLD and the AP MLD.

5. The apparatus of claim 1, wherein the first link is in a first frequency band, and at least one link of the one or more second links is in a second frequency band different from the first frequency band.

6. The apparatus of claim 1, wherein the first link and at least one link of the one or more second links are in a same frequency band.

7. The apparatus of claim 1, wherein the unavailability signaling information comprises a bitmap comprising a plurality of bits corresponding to a plurality of links, wherein a setting of a bit of the plurality of bits is to signal whether or not the unavailability state is to be set for a link corresponding to the bit.

8. The apparatus of claim 1 configured to cause the non-AP MLD to set the unavailability signaling information comprising one or more link Identifiers (IDs) of one or more respective links for which the unavailability state is to be set.

9. The apparatus of claim 1 configured to cause the non-AP MLD to process capability information from the AP MLD to identify a processing delay time for processing the unavailability signaling information, and to configure the unavailability signaling information based on the processing delay time.

10. The apparatus of claim 1 configured to cause the non-AP MLD to set the unavailability signaling information comprising unavailability reason information to signal a reason for setting the unavailability state.

11. The apparatus of claim 10 configured to cause the non-AP MLD to set the unavailability reason information to signal that the unavailability state over the first link is due to an Enhanced Multi Link Single Radio (EMLSR) constraint.

12. The apparatus of claim 10 configured to cause the non-AP MLD to set the unavailability reason information to signal that the unavailability state over the first link is to truncate a downlink transmission from the AP MLD to the non-AP MLD over the first link in order to allow an uplink transmission from the non-AP MLD to the AP MLD over a second link during the TxOP.

13. The apparatus of claim 1, wherein the unavailability signaling information is configured to signal a timing during the TxOP at which the unavailability state is to be applied.

14. The apparatus of claim 1 configured to cause the non-AP MLD to transmit the frame from a non-AP STA of the non-AP MLD in a role of a TxOP holder of the TxOP.

15. The apparatus of claim 1 configured to cause the non-AP MLD to transmit the frame from a non-AP STA of the non-AP MLD in a role of a TxOP responder of the TxOP.

16. The apparatus of claim 1 comprising a radio to transmit the frame, one or more antennas connected to the radio, and another processor to execute instructions of an operating system.

17. An apparatus comprising:
a processor configured to cause a non Access Point (AP) (non-AP) Multi-Link Device (MLD) to:
transmit a Multi-Link (ML) element to an AP MLD during setup of an ML connection between the non-AP MLD and the AP MLD, the ML element comprising availability/unavailability link-dependency signaling information to signal a setting dependency between a first link and one or more second links, the setting dependency comprising a dependency of a setting of an availability/unavailability state of the one or more second links on a setting of an availability/unavailability state of the first link;
transmit a frame to the AP MLD during a Transmit Opportunity (TxOP), the frame comprising unavailability signaling information to signal an unavailability state at which the non-AP MLD is to be unavailable for communication over the first link with the AP MLD during the TxOP; and
set the availability/unavailability state of the one or more second links for communication with the AP MLD during the TxOP according to the setting dependency; and
a memory to store information processed by the processor.

18. The apparatus of claim 17, wherein the availability/unavailability link-dependency signaling information is configured to signal whether or not the unavailability state is to be set for all links between the non-AP MLD and the AP MLD when the unavailability state is to be set for the first link.

19. The apparatus of claim 17, wherein the availability/unavailability link-dependency signaling information is configured to signal whether or not the unavailability state is to be set for all links between the non-AP MLD and the AP MLD, which are in a same frequency band as the first link, when the unavailability state is to be set for the first link.

20. The apparatus of claim 17 configured to cause the non-AP MLD to set the availability/unavailability link-dependency signaling information comprising an MLD-unavailability bit configured to signal whether or not the unavailability state is to be set for all links between the non-AP MLD and the AP MLD when the unavailability state is to be set for the first link.
